(19) United States
(12) Patent Application Publication
(10) Pub. No.: US 2020/0191917 A1
(43) Pub. Date: Jun. 18, 2020

(54) IMAGE PROCESSING DEVICE, DISTANCE DETECTION DEVICE, IMAGE PROCESSING METHOD, AND NON-TRANSITORY STORAGE MEDIUM

(71) Applicant: Panasonic Intellectual Property Management Co., Ltd., Osaka (JP)

(72) Inventors: Tsukasa OKADA, Osaka (JP); Tomohide ISHIGAMI, Osaka (JP)

(21) Appl. No.: 16/796,403

(22) Filed: Feb. 20, 2020

Related U.S. Application Data
(63) Continuation of application No. PCT/JP2018/020255, filed on May 28, 2018.

(30) Foreign Application Priority Data
Aug. 23, 2017 (JP) 2017-160022

(51) Int. Cl. G01S 7/487; G06T 7/70; G01S 17/08

(52) U.S. Cl. CPC G01S 7/487; G01S 17/08; G06T 7/70

(57) ABSTRACT

An image processing device decides, on a scanning line of a taken image of a space irradiated with light having directionality, a first pixel block including a determination target pixel, a second pixel block adjacent to the first pixel block, and a third pixel block adjacent to the first pixel block on a side opposite to the second pixel block. Furthermore, the image processing device determines whether or not the determination target pixel is a pixel showing the irradiating light based on a relationship among a first luminance sum based on a sum of luminance values of pixels included in the first pixel block, a second luminance sum based on a sum of luminance values of pixels included in the second pixel block, and a third luminance sum based on a sum of luminance values of pixels included in the third pixel block.

### BACKGROUND

### 1. Technical Field

The present disclosure relates to an image processing device, a distance detection device, an image processing method, and a program.

### 2. Description of the Related Art

Studies are being made on a technique for detecting an object in a space by taking an image of the space irradiated with light having directionality such as laser and analyzing the taken image. According to such a technique, presence or absence of an object is detected based on a change of a shape, a position, and the like of an image of the light on the taken image caused by reflection of the light having directionality on the object. For example, Patent Literature (PTL 1) describes an obstacle detection device that includes an emitter that emits a laser beam extending along a virtual plane, an image sensor covering a field of view that crosses the virtual plane, and an image analyzing unit. The image analyzing unit detects an obstacle by detecting a change of an image of the laser beam on an image generated by the image sensor.

PTL 1 is Japanese Translation of PCT International Application Publication No. 2017-518579.

### SUMMARY

An image taken by an imaging device such as an image sensor sometimes includes not only an image of a laser beam, but also an image of sunlight. Some laser beams have a wavelength that is within a wavelength range of sunlight. In such a case, luminance of an image of sunlight and luminance of an image of the laser beam are close on the taken image. For this reason, the image of sunlight may be undesirably analyzed as an image of a laser beam. This causes error in detection of an object.

The present disclosure provides an image processing device, a distance detection device, an image processing method, and a program that improve detection accuracy of specific light on a taken image.

An image processing device according to a non-restrictive exemplary aspect of the present disclosure includes an irradiator that irradiates a space with irradiating light having directionality, an imaging unit that takes an image of the space, and a processor that detects a region irradiated with the irradiating light on the taken image. The processor scans the taken image along a scanning line, decides, on the scanning line, a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block, calculates a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block, and determines whether or not the determination target pixel is a pixel showing the irradiating light based on a relationship among the first luminance sum, the second luminance sum, and the third luminance sum.

An image processing device according to a non-restrictive exemplary aspect of the present disclosure includes a storage in which a taken image of a space irradiated with irradiating light having directionality is stored, and a processor that detects a region irradiated with the irradiating light on the taken image. The processor scans the taken image along a scanning line, decides, on the scanning line, a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block, calculates a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block, and determines whether or not the determination target pixel is a pixel showing the irradiating light based on a relationship among the first luminance sum, the second luminance sum, and the third luminance sum.

A distance detection device according to a non-restrictive exemplary aspect of the present disclosure includes the image processing device and a distance acquiring unit that calculates and outputs a distance to a position of reflection of the irradiating light based on a position, on the taken image, of the region irradiated with the irradiating light detected by the processor.

An image processing method according to a non-restrictive exemplary aspect of the present disclosure includes acquiring a taken image of a space irradiated with irradiating light having directionality and detecting a region irradiated with the irradiating light on the taken image. In the detecting the region irradiated with the irradiating light, the taken image is scanned along a scanning line, a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block are decided on the scanning line, a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block are calculated, and whether or not the determination target pixel is a pixel showing the irradiating light is determined based on a relationship among the first luminance sum, the second luminance sum, and the third luminance sum.

A program according to a non-restrictive exemplary aspect of the present disclosure causes a computer to execute a process including acquiring a taken image of a space irradiated with irradiating light having directionality and detecting a region irradiated with the irradiating light on the taken image, wherein in the detecting the region irradiated with the irradiating light, the taken image is scanned along a scanning line, a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block are decided on the scanning line, a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block are calculated, and whether or not the determination target pixel is a pixel showing the irradiating light is determined based on a relationship among the first luminance sum, the second luminance sum, and the third luminance sum.

Note that the above general or specific aspects may be implemented by a system, a device, a method, an integrated circuit, a computer program, or a recording medium such as a computer-readable recording disc or may be implemented by any combination of the system, the device, the method, the integrated circuit, the computer program, and the recording medium. Examples of the computer-readable recording medium include a non-volatile recording medium such as a compact disc-read only memory (CD-ROM).

According to the technique of the present disclosure, accuracy of detection of specific light on a taken image can be improved.

### BRIEF DESCRIPTION OF DRAWINGS

FIG. 1 illustrates an outline configuration of an object detection device according to an exemplary embodiment.

FIG. 2 illustrates a functional configuration of the object detection device according to the exemplary embodiment.

FIG. 3A illustrates an example of an image taken (when an object is close) by an imaging unit when scanning light of an irradiator is line laser.

FIG. 3B illustrates an example of an image taken (when an object is far) by the imaging unit when the scanning light of the irradiator is line laser.

FIG. 4A illustrates an example of a hardware configuration of an arithmetic processor.

FIG. 4B illustrates an example of a hardware configuration of a distance acquiring unit.

FIG. 5 is a flowchart illustrating an example of overall flow of processing operation of the arithmetic processor according to the exemplary embodiment.

FIG. 6 is a flowchart illustrating an example of details of a flow of convex filter determination processing in FIG. 5.

FIG. 7 schematically illustrates an example of a configuration of a taken image.

FIG. 8A illustrates an example of a determination target region set on a scanning line of a column number 1 on the taken image.

FIG. 8B illustrates an example of pixel blocks set in the determination target region.

FIG. 9 illustrates an example of a luminance distribution of pixels and a luminance distribution of scanning light corresponding to positions of the pixels when the determination target region includes a scanning light image.

FIG. 10 is a flowchart illustrating an example of an overall flow of processing operation of an arithmetic processor according to the modification.

FIG. 11 is a flowchart illustrating an example of details of a flow of sunlight filter determination processing in FIG. 10.

FIG. 12 illustrates an example of a taken image including a sunlight image.

FIG. 13 illustrates an example of a relationship between an average and variance of luminance values of sunlight and an average and variance of luminance values of light other than sunlight.

### DETAILED DESCRIPTION

[Inventor's Findings]

The inventors of the present disclosure, that is, the inventors of the present invention focused on a technique for detecting an object on scanning light by emitting light having directionality as the scanning light, taking an image of the scanning light, and analyzing the image of the scanning light as a technique for allowing a moving body such as a robot to detect an object such as an obstacle around the moving body. The moving body operates over a range from a bright place irradiated with light such as sunlight to a dark place and needs to move while detecting and avoiding a surrounding object in these places. One example of light having good directionality is laser. However, some laser beams have a wavelength that is within a wavelength range of sunlight. In such a case, luminance of an image of sunlight and luminance of an image of the laser are close on a taken image. The inventors of the present invention found that sunlight is sometimes recognized as laser in image analysis techniques such as the one disclosed in PTL 1. In view of this, the inventors of the present invention studied an image processing technique for detecting, on a taken image, specific light having directionality such as laser in such a manner that the specific light is distinguished from light, such as sunlight, other than the specific light. As a result, the inventors of the present invention invented the following technique to improve detection accuracy of specific light on a taken image.

An image processing device according to one aspect of the present disclosure includes an irradiator that irradiates a space with irradiating light having directionality, an imaging unit that takes an image of the space, and a processor that detects a region irradiated with the irradiating light on the taken image. The processor scans the taken image along a scanning line and decides, on the scanning line, a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block. The processor calculates a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block, and determines whether or not the determination target pixel is a pixel showing the irradiating light based on a relationship among the first luminance sum, the second luminance sum, and the third luminance sum.

In the above aspect, an irradiating light image has a width and therefore includes at least one pixel in a width direction. For example, when the first pixel block that includes the determination target pixel includes a larger number of irradiating light images, each of the second pixel block and the third pixel block may include a smaller number of irradiating light images or include no irradiating light image. That is, use of the pixel blocks makes it possible to clearly distinguish a region (i.e., a block) including an irradiating light image and a region (i.e., a block) including no irradiating light image. Furthermore, clear changes occur among the first luminance sum of the first pixel block, the second luminance sum of the second pixel block, and the third luminance sum of the third pixel block. It is therefore possible to determine whether or not the determination target pixel in the first pixel block is a pixel showing irradiating light based on the relationship among the first luminance sum, the second luminance sum, and the third luminance sum.

An image processing device according to another aspect of the present disclosure includes a storage in which a taken image of a space irradiated with irradiating light having directionality is stored and a processor that detects a region irradiated with the irradiating light on the taken image. The processor scans the taken image along a scanning line and decides, on the scanning line, a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block. The processor calculates a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block, and determines whether or not the determination target pixel is a pixel showing the irradiating light based on a relationship among the first luminance sum, the second luminance sum, and the third luminance sum. According to the aspect, an effect similar to the effect of the image processing device according to the one aspect of the present disclosure is obtained.

In the image processing device according to the one aspect of the present disclosure and the image processing device according to the other aspect of the present disclosure, the first luminance sum is a sum of the luminance values of the pixels included in the first pixel block, the second luminance sum is a sum of the luminance values of the pixels included in the second pixel block, and the third luminance sum is a sum of the luminance values of the pixels included in the third pixel block. The processor may calculate an evaluation value by subtracting the second luminance sum and the third luminance sum from a value that is twice the first luminance sum and determine that the determination target pixel is a pixel showing the irradiating light when the evaluation value is larger than a first threshold.

According to the above aspect, when the evaluation value is larger than the first threshold, the sum of the luminance values of the pixels included in the first pixel block can be larger than the sum of the luminance values of the pixels included in the second pixel block and the third pixel block. It can therefore be regarded that the first pixel block includes an irradiating light image and the determination target pixel is the pixel showing irradiating light.

In the image processing device according to the one aspect of the present disclosure and the image processing device according to the other aspect of the present disclosure, the processor may further determine that the determination target pixel is a pixel showing the irradiating light when a difference between the second luminance sum and the third luminance sum is less than a second threshold.

According to the above aspect, a case where one of the second luminance sum and the third luminance sum is markedly larger than the other one of the second luminance sum and the third luminance sum is excluded. For example, when the larger one of the second luminance sum and the third luminance sum is close to the first luminance sum, it is possible that a light image included in the first pixel block is also included in a pixel block having the larger one of the second luminance sum and the third luminance sum. Such a light image can be excluded from irradiating light. This improves accuracy of detection of irradiating light on a taken image.

In the image processing device according to the one aspect of the present disclosure and the image processing device according to the other aspect of the present disclosure, the processor may change the first threshold when each of the second luminance sum and the third luminance sum is less than or equal to a third threshold or when the first luminance sum is larger than or equal to a fourth threshold.

According to the above aspect, the first threshold is changed when the second luminance sum and the third luminance sum are small or when the first luminance sum is large. For example, when the second pixel block and the third pixel block indicate an image of a target object having a dark color on which irradiating light is not reflected, the second luminance sum and the third luminance sum become small. Meanwhile, for example, when the first pixel block indicates an image of a target object having a bright color on which irradiating light is reflected, the first luminance sum becomes large. This may decrease accuracy of determination as to whether or not a determination target pixel is a pixel showing irradiating light. In such a case, accuracy of the determination can be improved by changing the first threshold.

In the image processing device according to the one aspect of the present disclosure and the image processing device according to the other aspect of the present disclosure, the processor may decide a fourth pixel block including a plurality of pixels including a sunlight determination target pixel on the scanning line, calculate an average and a variance of luminance values of the pixels included in the fourth pixel block, and determine that the sunlight determination target pixel is a pixel showing sunlight when the average is larger than an average threshold or when the variance is larger than a variance threshold.

In the above aspect, characteristics of an average and a variance of luminance values of a plurality of pixels included in an image of sunlight are different from those of light other than sunlight. The average and variance of sunlight tend to be larger than light other than sunlight. Therefore, when the average is larger than the average threshold or the variance is larger than the variance threshold, it can be regarded that the fourth pixel block indicates a sunlight image. It can therefore be regarded that the sunlight determination target pixel is a pixel showing sunlight.

In the image processing device according to the one aspect of the present disclosure and the image processing device according to the other aspect of the present disclosure, the processor may determine that the taken image is an image showing sunlight when a proportion of the pixel showing sunlight determined to all of the sunlight determination target pixel on the taken image is larger than a first proportion threshold. According to the aspect, it is possible to determine whether or not a sunlight image is present on a whole taken image.

In the image processing device according to the one aspect of the present disclosure and the image processing device according to the other aspect of the present disclosure, the processor may determine that a taken image on the scanning line shows sunlight when a proportion of the pixel showing sunlight determined to all of the sunlight determination target pixel on the scanning line is larger than a second proportion threshold. According to the aspect, it is possible to determine, for each scanning line, whether or not a sunlight image is present on the taken image.

In the image processing device according to the one aspect of the present disclosure and the image processing device according to the other aspect of the present disclosure, the irradiating light may be light that is hard to spread in at least two opposite directions. According to the aspect, the irradiating light forms a dotted or linear image on the taken image. A difference in luminance between the irradiating light and surroundings thereof on the taken image is more likely to be reflected in the relationship among the first luminance sum, the second luminance sum, and the third luminance sum.

In the image processing device according to the one aspect of the present disclosure and the image processing device according to the other aspect of the present disclosure, each of widths of the first pixel block, the second pixel block, and the third pixel block in a direction along the scanning line may be larger than or equal to a width of the irradiating light on the taken image and less than or equal to a width that is twice the width of the irradiating light. According to the above aspect, the irradiating light is prevented from being included in all of the first pixel block, the second pixel block, and the third pixel block. Furthermore, the irradiating light can be included in the first pixel block only. This improves accuracy of the determination concerning the determination target pixel based on the relationship among the first luminance sum, the second luminance sum, and the third luminance sum.

In the image processing device according to the one aspect of the present disclosure and the image processing device according to the other aspect of the present disclosure, the second pixel block and the third pixel block may be decided at positions that are spaced apart from the first pixel block by a first interval on the scanning line, and the first interval may be larger than or equal to a width of the irradiating light on the taken image and less than or equal to a width that is twice the width of the irradiating light. According to the aspect, the irradiating light is prevented from being included in two or more of the first pixel block, the second pixel block, and the third pixel block. This improves accuracy of the determination concerning the determination target pixel based on the relationship among the first luminance sum, the second luminance sum, and the third luminance sum.

In the image processing device according to the one aspect of the present disclosure and the image processing device according to the other aspect of the present disclosure, the taken image may be an image taken through a bandpass filter that transmits the irradiating light. According to the aspect, the taken image is an image that shows only the irradiating light and light having a wavelength close to a wavelength of the irradiating light. This simplifies processing for detecting the irradiating light on the taken image.

A distance detection device according to one aspect of the present disclosure includes the image processing device and a distance acquiring unit that calculates and outputs a distance to a position of reflection of the irradiating light based on a position, on the taken image, of the region irradiated with the irradiating light detected by the processor. According to the aspect, an effect similar to the effect of the image processing device according to the one aspect of the present disclosure is obtained. Furthermore, a distance to a position at which the irradiating light was reflected calculated based on a position of the irradiating light detected with high accuracy can have high accuracy.

An image processing method according to one aspect of the present disclosure includes acquiring a taken image of a space irradiated with irradiating light having directionality and detecting a region irradiated with the irradiating light on the taken image; wherein in the detecting the region irradiated with the irradiating light, the taken image is scanned along a scanning line, a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block are decided on the scanning line, a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block are calculated, and whether or not the determination target pixel is a pixel showing the irradiating light is determined based on a relationship among the first luminance sum, the second luminance sum, and the third luminance sum. According to the aspect, an effect similar to the effect of the image processing device according to the one aspect of the present disclosure is obtained.

A program according to one aspect of the present disclosure causes a computer to execute a process including acquiring a taken image of a space irradiated with irradiating light having directionality and detecting a region irradiated with the irradiating light on the taken image, wherein in the detecting the region irradiated with the irradiating light, the taken image is scanned along a scanning line, a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block are decided on the scanning line, a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block are calculated, and whether or not the determination target pixel is a pixel showing the irradiating light is determined based on a relationship among the first luminance sum, the second luminance sum, and the third luminance sum. According to the aspect, an effect similar to the effect of the image processing device according to the one aspect of the present disclosure is obtained.

Note that the above general or specific aspects may be implemented by a system, a device, a method, an integrated circuit, a computer program, or a recording medium such as a computer-readable recording disc or may be implemented by any combination of the system, the device, the method, the integrated circuit, the computer program, and the recording medium. Examples of the computer-readable recording medium include a non-volatile recording medium such as a CD-ROM.

### Exemplary Embodiment

Hereinafter, an image processing device and others according to an exemplary embodiment of the present disclosure will be specifically described with reference to the drawings. The exemplary embodiment described below is general or specific example. Numerical values, shapes, components, arrangement positions and connection configurations of the components, steps, processing order of the steps, and the like shown in the following exemplary embodiment are just examples, and are not intended to limit the present disclosure. Further, among the components in the following exemplary embodiment, components that are not described in the independent claims indicating the highest concept are described as optional components. In the following description of the exemplary embodiment, expressions using “substantially” such as “substantially parallel” and “substantially orthogonal” are sometimes used. For example, “substantially parallel” means not only “completely parallel”, but also “practically parallel”. That is, “substantially parallel” encompasses, for example, a difference of approximately several percents. This applies to other expressions including “substantially”. Each drawing is a schematic view and is not necessarily strict. In the drawings, substantially same components are denoted by same reference numerals, and redundant description may be omitted or simplified.

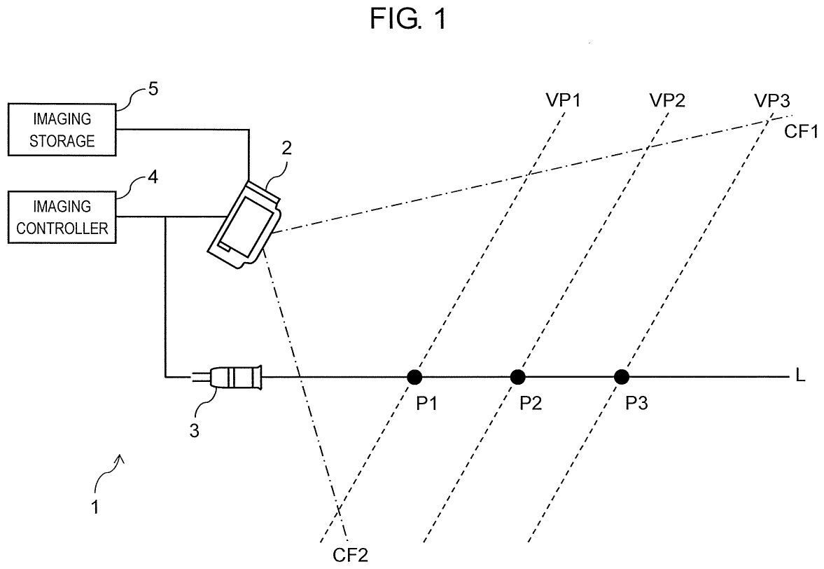

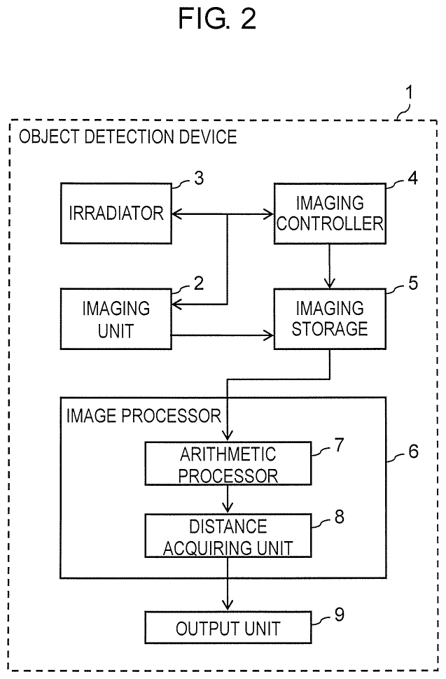

Object detection device 1 including an image processing device according to the exemplary embodiment is described below. Object detection device 1 is a device that detects a three-dimensional position of an object on scanning light by emitting light having directionality as the scanning light, taking an image of the scanning light, and analyzing the image of the scanning light. FIG. 1 illustrates an outline configuration of object detection device 1 according to the exemplary embodiment. FIG. 2 illustrates a functional configuration of object detection device 1 according to the exemplary embodiment. As illustrated in FIG. 1, object detection device 1 includes irradiator 3 that irradiates a space to be detected with scanning light, imaging unit 2 that takes an image of the space, imaging controller 4, and imaging storage 5. The components of object detection device 1 may be mounted in a single device or may be separately mounted in a plurality of devices. The “device” as used herein not only means a single device, but also can mean a system including a plurality of devices. Object detection device 1 is an example of a distance detection device.

In the present exemplary embodiment, irradiator 3 emits a single beam of scanning light L. Note, however, that irradiator 3 may emit two or more beams of scanning light. The scanning light L emitted from irradiator 3 is light having directionality. Scanning light L may be light that is hard to spread in at least two opposite directions. Examples of scanning light L include, but are not limited to, line laser and dotted laser using infrared light. The line laser is light that is hard to spread in two opposite directions. When the line laser hits a blocker such as a wall, linear reflected light is formed. The dotted laser is light that is hard to spread toward surroundings. When the dotted laser hits a blocker such as a wall, dotted reflected light is formed. Irradiator 3 is, for example, a laser emitter. Scanning light L is an example of irradiating light.

Imaging unit 2 takes an image of a space to which scanning light is emitted by irradiator 3. Imaging unit 2 causes the taken image to be stored in imaging storage 5. Imaging unit 2 and irradiator 3 are disposed such that scanning light L is emitted to a range within a field of view of imaging unit 2 between line CF1 and line CF2 extending from imaging unit 2. Relative positions and directions of imaging unit 2 and irradiator 3 may be fixed or may be unfixed. When one of imaging unit 2 and irradiator 3 is movable relative to the other, the movement of the one of imaging unit 2 and irradiator 3 may be controlled by imaging controller 4. Furthermore, imaging controller 4 may detect an amount and a direction of movement of imaging unit 2 or irradiator 3 by using, for example, a sensor (not illustrated) and calculate relative positions and directions of imaging unit 2 and irradiator 3. Imaging unit 2 takes an image of scanning light L reflected by an object within the field of view. Imaging unit 2 is, for example, a digital camera or video camera.

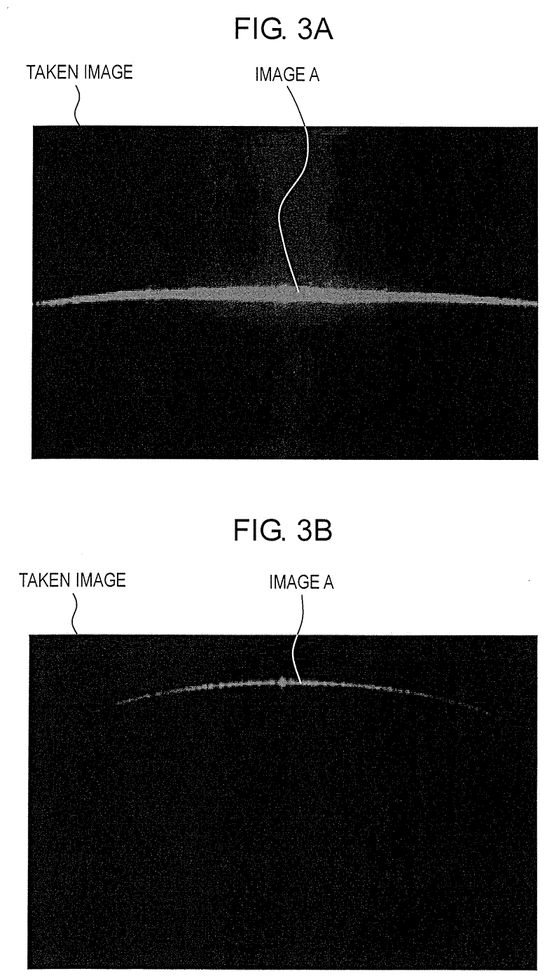

Imaging unit 2 may include a bandpass filter (not illustrated) and take an image that is incident through the bandpass filter. The bandpass filter is a filter that transmits only scanning light L of irradiator 3 and light having a wavelength close to a wavelength of scanning light L and blocks transmission of light having other wavelengths. A plurality of imaging pixels of imaging unit 2 that includes the bandpass filter acquire luminance of scanning light L and light having a wavelength close to a wavelength of scanning light L but hardly acquire luminance of light of other wavelengths. FIGS. 3A and 3B illustrate examples of images taken by imaging unit 2 when scanning light L of irradiator 3 is line laser. As illustrated in FIGS. 3A and 3B, on the taken image, an image of the line laser appears clear, and an image other than the line laser appears dark. FIG. 3A illustrates an example of an image taken by imaging unit 2 that is an image of scanning light reflected by a close object when the scanning light of irradiator 3 is line laser. FIG. 3B illustrates an example of an image taken by imaging unit 2 that is an image of scanning light reflected by a far object when the scanning light of irradiator 3 is line laser.

Imaging controller 4 controls operation of imaging unit 2 and irradiator 3. For example, imaging controller 4 controls the operation such that scanning light L emitting operation of irradiator 3 and imaging operation of imaging unit 2 are synchronized with each other. For example, irradiator 3 is movable when a space to be detected is scanned three-dimensionally by scanning light L. Imaging controller 4 may control movement of irradiator 3 during the three-dimensional scanning. The three-dimensional scanning is scanning that involves emission of scanning light L in various directions including upward, downward, leftward, and rightward directions. Furthermore, imaging controller 4 may calculate relative positions and directions of imaging unit 2 and irradiator 3. Imaging controller 4 may store, in imaging storage 5, relative positions and directions and an image taken when imaging unit 2 and irradiator 3 are in the relative positions and directions such that the relative positions and directions and the taken image are associated with each other. Furthermore, imaging controller 4 may control scanning light output from irradiator 3. For example, images obtained when output of scanning light of irradiator 3 is turned on and off may be taken by imaging unit 2. A luminance value of the scanning light itself can be obtained by finding a difference between the images obtained when the output of the scanning light is turned on and off. This is effective when object detection device 1 and an object to be detected are not moving.

Imaging controller 4 may be a computer system (not illustrated) including a processor such as a central processing unit (CPU) or a digital signal processor (DSP) and memories such as a random access memory (RAM) and a read-only memory (ROM). The CPU or DSP may execute a program recorded on the ROM while using the RAM as a working memory, and thus some or all of the functions of imaging controller 4 may be accomplished. Some or all of the functions of imaging controller 4 may be accomplished by a dedicated hardware circuit such as an electronic circuit or an integrated circuit. Some or all of the functions of imaging controller 4 may be accomplished by a combination of the software function and the hardware circuit. The program may be recorded in advance on the ROM or may be offered as an application through communication using a communication network such as the Internet, communication based on a mobile communication standard, or other kinds of communication such as a wireless network, a wired network, and broadcasting.

Imaging storage 5 can store therein information in such a manner that the stored image can be taken out. The information stored in imaging storage 5 is, for example, an image taken by imaging unit 2. Imaging storage 5 may store therein relative positions and directions of imaging unit 2 and irradiator 3 in association with a taken image. Imaging storage 5 is, for example, a storage device such as a semiconductor memory such as a ROM, a RAM, or a flash memory, a hard disk drive, or a solid state drive (SSD).

As illustrated in FIG. 2, object detection device 1 further includes image processor 6 and output unit 9. Image processor 6 processes a taken image stored in imaging storage 5 and outputs a processing result to output unit 9. Image processor 6 detects a scanning light image on the taken image and calculates a distance between a target object on which the detected scanning light was reflected and object detection device 1 based on a position of the detected scanning light image on the taken image. Furthermore, image processor 6 calculates a three-dimensional position of the target object based on the calculated distance and a direction of projection of the scanning light by irradiator 3. Then, image processor 6 supplies the calculated three-dimensional position of the target object to output unit 9. For example, FIG. 1 shows that a position of an image of scanning light L reflected at point P1, a position of an image of scanning light L reflected at point P2, and a position of an image of scanning light L reflected at point P3 are different on a taken image. In FIG. 1, virtual planes VP1, VP2, and VP3 are virtual planes that pass points P1, P2, and P3, respectively and are parallel with a plane of the taken image. A distance from imaging unit 2 becomes longer in an order of virtual planes VP1, VP2, and VP3. Distances between object detection device 1 and the points can be calculated from the positions of the images on the taken image. For example, FIG. 3A illustrates an example of an image of scanning light L reflected at point P1 close to imaging unit 2, and FIG. 3B illustrates an example of an image of scanning light L reflected at point P3 far from imaging unit 2. Details of image processor 6 will be described later.

Output unit 9 outputs a position of a target object acquired from image processor 6. Output unit 9 may be a display that visualizes information, may be a speaker that outputs information as sound, or may be a communication interface that outputs information to an outside. The communication interface may be an interface for wired communication or may be an interface for wireless communication. The display is, for example, a display panel such as a liquid crystal panel or an organic or inorganic electroluminescence (EL) panel. Output unit 9 may not only output the position, but also determine and output presence or absence of an obstacle based on the position. For example, when an obstacle is present, output unit 9 may output this information to an outside as sound or an image.

Image processor 6 includes arithmetic processor 7 that detects a region of a scanning light image on a taken image and distance acquiring unit 8 that calculates a distance between a target object on which the scanning light was reflected and object detection device 1 based on a position of the scanning light image on the taken image. Distance acquiring unit 8 calculates a distance between a target object on which scanning light was reflected and object detection device 1 based on a position and a shape of a scanning light image detected by arithmetic processor 7 on a taken image. For example, on the taken image illustrated in FIG. 3A or 3B, image A extending laterally on the taken image is detected as an image of scanning light that is line laser by arithmetic processor 7. Distance acquiring unit 8 calculates distances from object detection device 1 to target parts on which the scanning light was reflected based on vertical positions of columns of image A on the taken image and relative positions and directions of imaging unit 2 and irradiator 3. Furthermore, distance acquiring unit 8 may calculate three-dimensional positions of the target parts based on the calculated distances and the relative positions and directions of imaging unit 2 and irradiator 3. A method for calculating distances to the target parts and three-dimensional positions of the target parts is a known technique such as triangulation, and therefore detailed description thereof is omitted. Arithmetic processor 7 is an example of a processor of the image processing device. Image processor 6 is an example of a distance detection device.

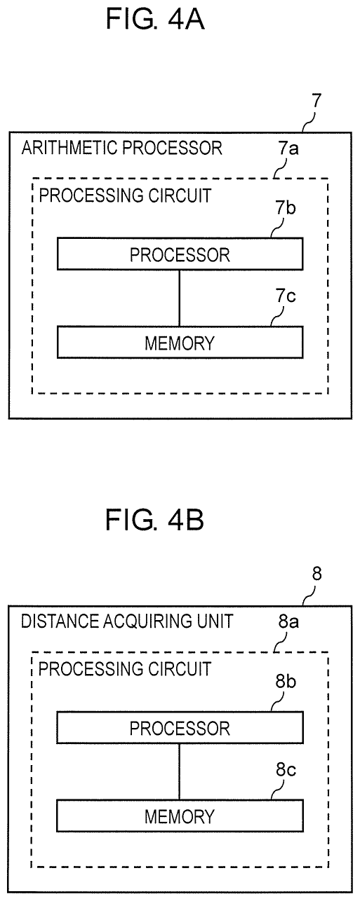

As illustrated in FIGS. 4A and 4B, arithmetic processor 7 and distance acquiring unit 8 may be constituted by processing circuits 7a and 8a, respectively that include processors 7b and 8b such as CPUs or DSPs and memories 7c and 8c such as RAMS and ROMs, respectively. FIGS. 4A and 4B illustrate examples of hardware configurations of arithmetic processor 7 and distance acquiring unit 8. The CPU or DSP may execute a program recorded on the ROM while using the RAM as a working memory, and thus some or all of functions of arithmetic processor 7 and distance acquiring unit 8 may be accomplished. Some or all of the functions of arithmetic processor 7 and distance acquiring unit 8 may be accomplished by a dedicated hardware circuit such as an electronic circuit or an integrated circuit. Some or all of the functions of arithmetic processor 7 and distance acquiring unit 8 may be accomplished by a combination of the software function and the hardware circuit. The program may be recorded in advance on the ROM or may be offered as an application through communication using a communication network such as the Internet, communication based on a mobile communication standard, or other kinds of communication such as a wireless network, a wired network, and broadcasting. Processor 7b of arithmetic processor 7 and processor 8b of distance acquiring unit 8 may be unified into a single processor, and memory 7c of arithmetic processor 7 and memory 8c of distance acquiring unit 8 may be unified into a single memory. Arithmetic processor 7 is an example of the image processing device, processor 7b of arithmetic processor 7 is an example of a processor of the image processing device, and memory 7c of arithmetic processor 7 is an example of a storage of the image processing device.

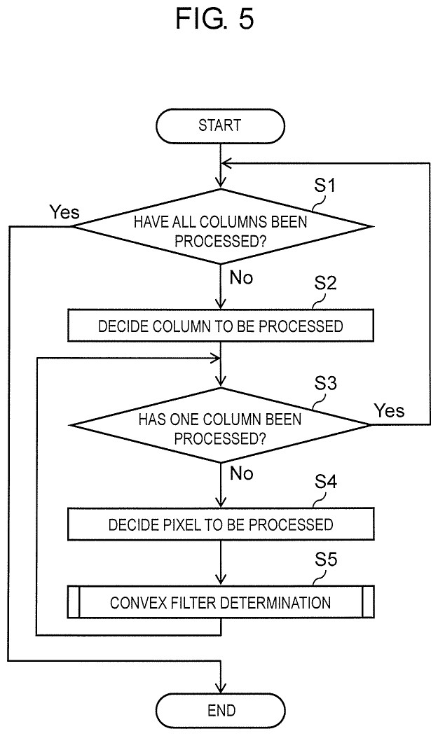

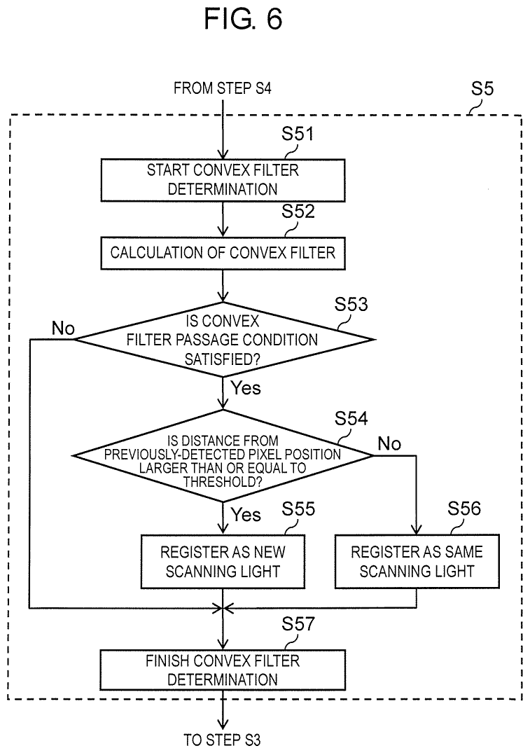

Details of processing operation of arithmetic processor 7 are described below. FIG. 5 is a flowchart illustrating an example of an overall flow of the processing operation of arithmetic processor 7. FIG. 6 is a flowchart illustrating an example of details of a flow of convex filter determination processing in FIG. 5. As illustrated in FIG. 5, in step S1, arithmetic processor 7 determines whether or not image processing of all pixel columns of a taken image has been completed. Arithmetic processor 7 finishes the processing on the taken image when the image processing of all pixel columns of the taken image has been completed (Yes in step S1), and proceeds to step S2 when the image processing of all pixel columns of the taken image has not been completed (No in step S1). The image processing is processes in steps S2 to S5.

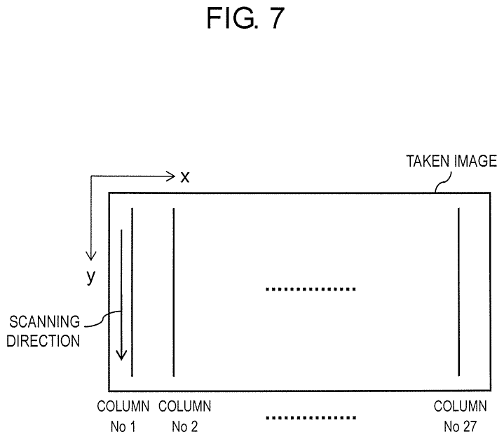

In the present exemplary embodiment, it is assumed hereinafter that the taken image is made up of a plurality of pixels arranged in a matrix of horizontal 320 pixels×vertical 180 pixels. Note, however, that this configuration is not restrictive. As illustrated in FIG. 7, arithmetic processor 7 sets pixel coordinates on the taken image such that an upper left corner of the taken image in FIG. 7 is used as an origin and an x-axis and a y-axis are used as coordinate axes. FIG. 7 schematically illustrates an example of a configuration of the taken image. The x-axis is an axis along a direction in which the horizontal 320 pixels are aligned, and the y-axis is an axis along a direction in which the vertical 180 pixels are aligned. Arithmetic processor 7 determines in the processes in steps S1 to S5 whether or not a pixel value (i.e., a luminance value) of each pixel of the taken image indicates a scanning light image.

In this processing, arithmetic processor 7 sets a scanning line parallel with the y-axis of the taken image. Furthermore, arithmetic processor 7 sequentially scans pixels included in a pixel column on the scanning line and performs the aforementioned determination on each of the scanned pixels. The taken image includes 320 pixel columns. In the present exemplary embodiment, arithmetic processor 7 performs the scanning for the determination on some of the 320 pixel columns to increase a processing speed. Specifically, arithmetic processor 7 scans 27 pixel columns. A pixel column to be scanned is selected per 12 pixel columns. That is, pixel columns given column numbers 1 to 27 are selected by arithmetic processor 7. All pixel columns in step S1 mean all of the pixel columns given the column numbers 1 to 27. Note that a number of pixel columns processed by arithmetic processor 7 and an interval between pixel columns are not limited to the ones described above and can be any number and interval. Arithmetic processor 7 may scan all of the pixel columns included in the taken image.

In step S2, arithmetic processor 7 decides, as a pixel column to be subjected to the image processing, a pixel column of a column number that has not been subjected to the processes in steps S3 to S5 that will be described later among the pixel columns given the column numbers 1 to 27. Note that arithmetic processor 7 may cause a column number of a pixel column that has been subjected to the image processing to be stored in memory 7c and decide a column number to be subjected to the image processing based on the column number stored in memory 7c. In this step, arithmetic processor 7 decides a column number in ascending order or descending order, for example.

Next, in step S3, arithmetic processor 7 determines whether or not the processes in S4 and S5 that will be described later have been completed on a plurality of pixels included in the decided pixel column, that is, on all of a plurality of pixels on the scanning line. Arithmetic processor 7 returns to step S1 when the processes have been completed (Yes in step S3), and proceeds to step S4 when the processes have not been completed (No in step S3). Note that not all of the plurality of pixels on the scanning line need be subjected to the processes.

In step S4, arithmetic processor 7 decides, as a pixel to be processed, a pixel that has not been subjected to the process in step S5 that will be described later among the pixels on the scanning line. Note that arithmetic processor 7 may cause pixel coordinates of a pixel that has been already processed to be stored in memory 7c and decide a pixel to be processed based on the pixel coordinates stored in memory 7c. In this step, arithmetic processor 7 decides pixels in a scanning direction that is a positive direction of the y-axis. However, this is not restrictive.

In step S5, arithmetic processor 7 determines whether or not the pixel decided in step S4 is a pixel that can pass a convex filter, that is, performs convex filter determination. The convex filter is a determination process concerning a pixel in the image processing. Arithmetic processor 7 determines that a luminance value of a pixel that can pass the convex filter indicates a scanning light image and determines that a luminance value of a pixel that cannot pass the convex filter does not indicate the scanning light image. Furthermore, when a plurality of pixels that pass the convex filter have been detected on a same scanning line in the convex filter determination, arithmetic processor 7 determines whether or not the detected plurality of pixels indicate an image of a single beam of scanning light that is continuous on the scanning line or images of separate beams of scanning light. Arithmetic processor 7 causes a determination result concerning each pixel to be stored in memory 7c. Alternatively, arithmetic processor 7 may cause a determination result concerning each pixel to be stored in imaging storage 5. Details of the convex filter determination processing will be described later. After completion of the process in step S5, arithmetic processor 7 returns to step S3.

As described above, arithmetic processor 7 determines whether or not pixels indicate a scanning light image by performing the convex filter determination process on all pixels included in each scanning line. Furthermore, arithmetic processor 7 determines whether or not a plurality of pixels each indicating a scanning light image indicate an image of a single continuous beam of scanning light or images of separate beams of scanning light and thus specifies a scanning light image(s) indicated by the pixels.

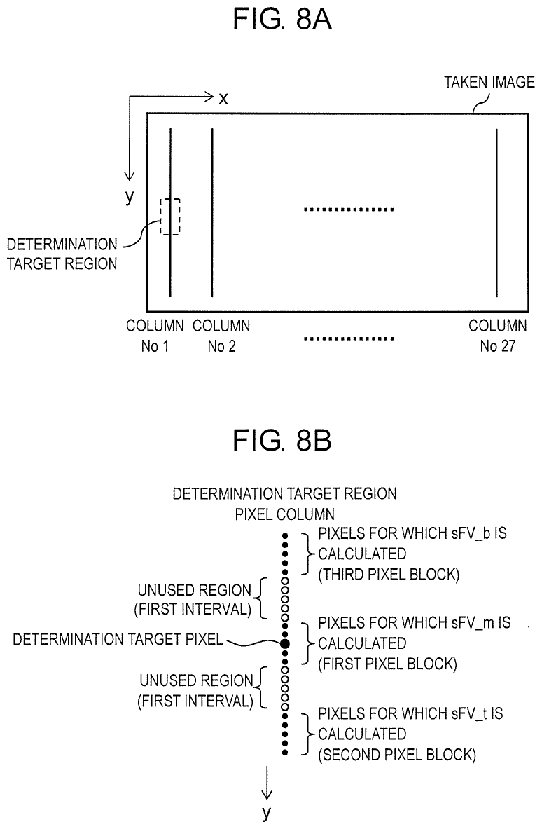

Details of the convex filter determination process in step S5 are described below. As illustrated in FIG. 6, in step S51, arithmetic processor 7 starts the convex filter determination processing on the pixel (hereinafter referred to as a “determination target pixel”) decided in step S4. As illustrated in FIG. 8A, arithmetic processor 7 sets a determination target region on a scanning line including the determination target pixel. FIG. 8A illustrates an example of a determination target region set on a scanning line of the column number 1 on the taken image. In the present exemplary embodiment, the determination target region is made up of 25 pixels including the determination target pixel. Note, however, that this configuration is not restrictive. The determination target pixel is a pixel located at a center of the 25 pixels. That is, the determination target region is a region including the determination target pixel and 12 pixels on a positive side of the determination target pixel on the y-axis and 12 pixels on a negative side of the determination target pixel on the y-axis. Note that when a y coordinate of the determination target pixel is small, a number of pixels included in the determination target region on a negative side on the y-axis may be less than 12. A position of the determination target pixel in the determination target region is not limited to the center.

As illustrated in FIG. 8B, arithmetic processor 7 defines, in the determination target region, a first pixel block including the determination target pixel and two pixels on a positive side of the determination target pixel on the y-axis and two pixels on a negative side of the determination target pixel on the y-axis. The first pixel block includes 5 pixels. FIG. 8B illustrates an example of pixel blocks set in the determination target region. Furthermore, arithmetic processor 7 sets a second pixel block that is adjacent to the first pixel block on the positive side on the y-axis and a third pixel block that is adjacent to the first pixel block on the negative side on the y-axis. Similar to the first pixel block, the second pixel block and the third pixel block each include 5 pixels. The second pixel block and the third pixel block each are spaced apart from the first pixel block by a first interval on the scanning line. In the present exemplary embodiment, the first interval includes 5 pixels. Note that a width in the y-axis direction of each of the first pixel block, the second pixel block, the third pixel block, and the first interval is not limited to 5 pixels. Note also that the widths in the y-axis direction of the first pixel block, the second pixel block, the third pixel block, and the first interval need not be same. Note also that an interval between the first pixel block and the second pixel block and an interval between the first pixel block and the third pixel block are the same first interval but need not necessarily be the same. To compare luminance of one pixel block and luminance of another pixel block when the widths in the y-axis direction are not the same, average luminance per pixel in one pixel block and average luminance per pixel in the other pixel block are compared.

The widths in the y-axis direction of the first pixel block, the second pixel block, the third pixel block, and the first interval are preferably larger than or equal to a width which a scanning light image can have on a taken image. In this case, each of the first pixel block, the second pixel block, the third pixel block, and the first interval can include a whole image of a single beam of scanning light in the y-axis direction. Furthermore, a single scanning light image is prevented from straddling the first pixel block and the second pixel block and straddling the first pixel block and the third pixel block.

The widths in the y-axis direction of the first pixel block, the second pixel block, the third pixel block, and the first interval are preferably less than or equal to a width that is twice the width which a scanning light image can have on a taken image. In this case, the first pixel block, the second pixel block, the third pixel block, and the first interval can be prevented from including wholes of two scanning light images arranged in the y-axis direction.

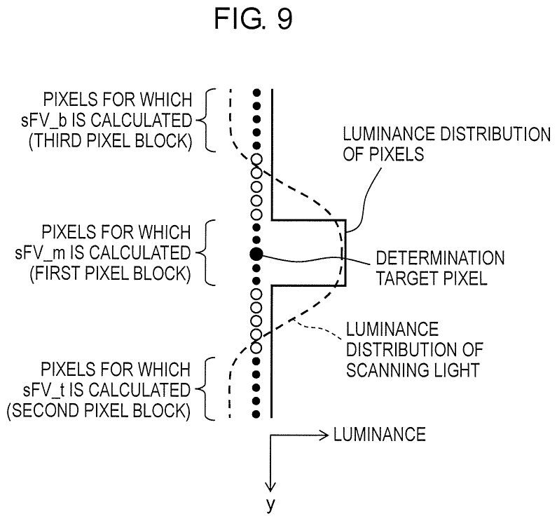

For example, FIG. 9 illustrates an example of a luminance distribution of pixels and a luminance distribution of scanning light corresponding to positions of the pixels when the determination target region includes a scanning light image. The luminance distribution of the scanning light is indicated by a convex mountain-shaped part of the broken curve that overlaps the first pixel block. The luminance distribution of the scanning light has a maximal part in which substantially constant maximal values are successive. In the example of FIG. 9, the position of the determination target pixel corresponds to a substantially central position of the maximal part. A width of the maximal part in the y-axis direction corresponds to a width of the scanning light image on the taken image, and an image of the maximal part of the scanning light is included in the first pixel block. Among the pixels in the determination target region that shows the scanning light image, each of the pixels in the first pixel block exhibits a high luminance value reflecting luminance of the scanning light, and each of the pixels in the second pixel block and the third pixel block does not reflect the luminance of the scanning light and exhibits a low luminance value.

By setting the widths in the y-axis direction of the first pixel block, the second pixel block, the third pixel block, and the first interval within the above range, a luminance distribution in which a luminance distribution of the first pixel block sticks out from luminance distributions of the second pixel block and the third pixel block can be obtained as illustrated in FIG. 9 when a scanning light image is present within the first pixel block. In other words, when the first pixel block, the second pixel block, and the third pixel block exhibit a convex luminance distribution like the one illustrated in FIG. 9, it can be regarded that the scanning light image is present in the first pixel block. For example, when pixels in the determination target region receive sunlight or reflected light thereof, an image of sunlight, which is diffusion light, is likely to exceed the first pixel block and reach the second pixel block and the third pixel block.

Arithmetic processor 7 determines that a luminance value of the determination target pixel indicates the scanning light image when the determination target pixel is included in pixels that form a convex luminance distribution. Herein, such determination processing concerning a pixel based on a convex luminance distribution is referred to as convex filter determination processing. Subsequent steps are a specific method for determining whether or not the determination target pixel is included in pixels that form a convex luminance distribution, that is, whether or not the determination target pixel passes the convex filter.

In step S52 of FIG. 6, arithmetic processor 7 performs calculations for the convex filter determination. Specifically, arithmetic processor 7 calculates first luminance sum sFV_m, which is a sum of luminance values of all pixels (pixels to be calculated) included in the first pixel block. Furthermore, arithmetic processor 7 calculates second luminance sum sFV_t, which is a sum of luminance values of all pixels (pixels to be calculated) included in the second pixel block. Furthermore, arithmetic processor 7 calculates third luminance sum sFV_b, which is a sum of luminance values of all pixels (pixels to be calculated) included in the third pixel block. In addition, arithmetic processor 7 calculates evaluation value sFV by subtracting the second luminance sum and the third luminance sum from a value that is twice the first luminance sum. That is, evaluation value sFV=2×sFV_m−sFV_b−sFV_t is satisfied. Whether or not the determination target pixel passes the convex filter is determined by using evaluation value sFV, first luminance sum sFV_m, second luminance sum sFV_b, and third luminance sum sFV_t. The 10 pixels included in the first interval are not used for the convex filter passage determination. That is, the first interval is an unused region and is a margin region that prevents a single scanning light image from straddling two pixel blocks.

Next, in step S53, arithmetic processor 7 determines whether or not the first luminance sum, the second luminance sum, the third luminance sum, and the evaluation value satisfy a convex filter passage condition. Arithmetic processor 7 proceeds to step S54 when the convex filter passage condition is satisfied (Yes in step S53) and proceeds to step S57 when the convex filter passage condition is not satisfied (No in step S53). Note that when the convex filter passage condition is satisfied, a luminance value of the determination target pixel in the first pixel block indicates the scanning light image, and when the convex filter passage condition is not satisfied, a luminance value of the determination target pixel in the first pixel block does not indicate the scanning light image.

The convex filter passage condition is stored in advance in memory 7c of arithmetic processor 7. The convex filter passage condition includes the following three conditions.

First condition: the evaluation value is larger than a first threshold, that is, sFV is larger than the first threshold.

Second condition: a difference between the second luminance sum and the third luminance sum is smaller than a second threshold, that is, |sFV_b−sFV_t| is smaller than the second threshold.

Third condition: the second luminance sum and the third luminance sum are less than or equal to a third threshold, or the first luminance sum is larger than or equal to a fourth threshold, that is, sFV_b and sFV_t are less than or equal to the third threshold, or sFV_m is larger than or equal to the fourth threshold.

The first condition means that the luminance distribution of the first pixel block, the second pixel block, and the third pixel block is a convex luminance distribution. The second condition means that a case where one of the second luminance sum and the third luminance is markedly large and the other one of the second luminance sum and the third luminance is markedly small is excluded. In such a case, the larger luminance sum sometimes becomes close to the first luminance sum even if the first condition is satisfied. It is highly likely that an image indicated by pixels having such a luminance distribution is not a scanning light image. The third condition is a condition that changes the first threshold and the second threshold in consideration of influence of surroundings of a target object on which scanning light is reflected. The first luminance sum, the second luminance sum, and the third luminance sum change in accordance with a color of the target object and surroundings thereof.

For example, when a color of the target object or surroundings thereof is dark, for example, when the target object or the surroundings thereof is a black wall and where the first pixel block includes a scanning light image, the second luminance sum and the third luminance sum sometimes become very small. Furthermore, the first luminance sum also becomes small. In this case, the evaluation value tends to become small and is highly likely to be smaller than the first threshold. Meanwhile, when a color of the target object or surroundings thereof is bright, for example, when the target object or the surroundings thereof is a white wall and where the first pixel block includes a scanning light image, the first luminance sum sometimes becomes very large. In this case, the evaluation value tends to become large and is highly likely to be larger than the first threshold. In view of this, arithmetic processor 7 changes (decreases) at least one of the first threshold and the second threshold, for example, to 50 when sFV_b and sFV_t are less than or equal to the third threshold. Alternatively, arithmetic processor 7 changes (increases) at least one of the first threshold and the second threshold, for example, to 480 when sFV_m is larger than or equal to the fourth threshold.

Note that the first threshold is, for example, 240. An average of evaluation values of a plurality of images taken under various conditions (e.g., a black wall and a white wall) is decided as a criterion. As for the first threshold changed by the third threshold, an average of evaluation values of a plurality of images taken under a condition (e.g., a black wall) in which luminance values of the second pixel block and the third pixel block tend to become small is decided as a criterion. As for the first threshold changed by the fourth threshold, an average of evaluation values of a plurality of images taken under a condition (e.g., a white wall) in which a luminance value of the first pixel block tends to become large is decided as a criterion.

The second threshold is, for example, 50. An average of differences |sFV_b−sFV_t| of a plurality of images taken under a condition (e.g., a white wall) in which a luminance value of the second pixel block or the third pixel block tends to become large is decided as a criterion.

The third threshold is, for example, 60. An average of the second luminance sums of the second pixel blocks and the third luminance sums of the third pixel blocks of a plurality of images taken under a condition (e.g., a black wall) in which a luminance value of the second pixel block or the third pixel block tends to become small is decided as a criterion.

The fourth threshold is, for example, 550. An average of the first luminance sums of the first pixel blocks of a plurality of images taken under a condition (e.g., a white wall) in which a luminance value of the first pixel block tends to become large is decided as a criterion.

Arithmetic processor 7 uses at least the first condition as the convex filter passage condition among the first through third conditions. Arithmetic processor 7 may use the first condition and at least one of the second and third conditions as the convex filter passage condition. When the convex filter passage condition includes the second condition, a case where the second luminance sum or the third luminance sum may be one (e.g., close to the first luminance sum) that does not correspond to a luminance distribution of a scanning light image is excluded from cases where the first condition is satisfied. This improves accuracy of the convex filter. When the convex filter passage condition includes the third condition, the thresholds of the first condition and the second condition are changed in accordance with a color of a target object or surroundings thereof on which scanning light is reflected. This allows the convex filter to have a function according to the target object or the surrounding environment thereof, thereby improving accuracy of the convex filter.

Next, in step S54, arithmetic processor 7 determines whether or not a distance from a position of a previously-detected pixel to the position of the determination target pixel is larger than or equal to a fifth threshold on the taken image. The previously-detected pixel is a pixel that passed the convex filter immediately before the determination target pixel on the scanning line on which the determination target pixel is present. In step S54, it is determined whether or not the determination target pixel and the previously-detected pixel indicate a same scanning light image. Arithmetic processor 7 proceeds to step S55 when the distance is larger than or equal to the fifth threshold (Yes in step S54), and proceeds to step S56 when the distance is less than the fifth threshold (No in step S54). Note that the fifth threshold is preferably larger than a width which a scanning light image can have on a taken image. In the present exemplary embodiment, the fifth threshold is a distance corresponding to 15 pixels.

The distance may be a distance between the determination target pixel and the previously-detected pixel, may be a distance between any position in the determination target region including the determination target pixel and the previously-detected pixel, or may be a distance between any position in the determination target region including the determination target pixel and any position in a determination target region including the previously-detected pixel. The distance may be a distance between the determination target pixel and a pixel having maximum luminance in the determination target region including the previously-detected pixel, may be a distance between a pixel having maximum luminance in the determination target region including the determination target pixel and the previously-detected pixel, or may be a distance between pixels having maximum luminance in the two determination target regions.

In step S55, arithmetic processor 7 determines that the determination target pixel indicates a new scanning light image and registers the determination target pixel in memory 7c. The case where “the determination target pixel indicates a new scanning light image” means that the scanning light image indicated by the determination target pixel and a scanning light image indicated by the previously-detected pixel are not continuous on a same scanning line and do not form a single image. For example, when a target object on which scanning light is reflected has irregularities or a step, an image formed on the taken image by a single beam of scanning light does not form a single continuous line but sometimes forms a plurality of separate lines. In such a case, the determination target pixel in this step can occur. Furthermore, for example, when an image of reflected sunlight is shown on the taken image and is elongated horizontally, the light may be detected as different scanning light. Although an example in which irradiator 3 outputs a single beam of scanning light has been described in the present exemplary embodiment, irradiator 3 may emit two or more beams of scanning light. By performing the processes in steps S54 to S56, scanning light can be distinguished between different scanning light and same scanning light.

In step S56, arithmetic processor 7 determines that the determination target pixel indicates a scanning light image same as before and registers the determination target pixel in memory 7c. The case in which the determination target pixel indicates a scanning light image same as before means that the scanning light image indicated by the determination target pixel and a scanning light image indicated by the previously-detected pixel are continuous on the same scanning line and form a single image. In this way, information of the pixel that indicates the same scanning light image is stored in memory 7c. The information of the pixel may be information including scanning light corresponding to the pixel, pixel coordinates of the pixel, and other information. Furthermore, arithmetic processor 7 may calculate, from among pixels determined as pixels that indicate a same scanning light image on a same scanning line, a central position of the scanning light image, and register the central position in memory 7c. In this case, arithmetic processor 7 may regard the central position of the scanning light as a position of a pixel having a maximum luminance value in the scanning light image or may regard the central position of the scanning light as a position of a pixel at a center of a width of the scanning light image on the scanning line. The central position of the scanning light image thus calculated can be used for distance calculation by distance acquiring unit 8. Note that distance acquiring unit 8 may calculate the central position of the scanning light image from the information of the pixels that indicate the same scanning light image stored in memory 7c.

In step S57 that follows steps S53, S55, and S56, arithmetic processor 7 finishes the convex filter determination processing on the determination target pixel and proceeds to step S3. By performing the processes in steps S51 to S57, arithmetic processor 7 specifies whether or not the determination target pixel indicates a scanning light image and a scanning light image indicated by the determination target pixel.

Furthermore, arithmetic processor 7 may calculate, based on determination results, a number of scanning light images formed by a plurality of pixels (hereinafter also referred to as “detected pixels”) that indicate scanning light on a scanning line on which each pixel has been subjected to the convex filter determination. Furthermore, arithmetic processor 7 may determine that a scanning light image on a scanning line is a true scanning light image when the number of scanning light images is less than or equal to a sixth threshold, and determine that a scanning light image on a scanning line is not a true scanning light image when the number of scanning light images is larger than the sixth threshold. As described above, an image formed on a taken image by a single beam of scanning light sometimes forms a plurality of separate lines due to influence of irregularities, a step, and the like of a target object on which the scanning light is reflected. An upper limit of a number of such lines varies depending on a target object on which scanning light is reflected but is limited. The sixth threshold is such an upper-limit value or a value close to the upper-limit value. In the present exemplary embodiment, the sixth threshold is “2”. When the number of scanning light images is larger than the sixth threshold, it is highly likely that these images include an image other than scanning light.

According to the above exemplary embodiment, arithmetic processor 7 decides, on a scanning line of a taken image, a first pixel block that includes a determination target pixel, a second pixel block that is adjacent to the first pixel block, and a third pixel block that is adjacent to the first pixel block on a side opposite to the second pixel block. Furthermore, arithmetic processor 7 determines whether or not the determination target pixel is a pixel showing scanning light based on a relationship among a first luminance sum based on a sum of luminance values of pixels included in the first pixel block, a second luminance sum based a sum of luminance values of pixels included in the second pixel block, and a third luminance sum based on a sum of luminance values of pixels included in the third pixel block.

In the above configuration, a scanning light image has a width and therefore includes at least one pixel in a width direction. For example, when the first pixel block that includes the determination target pixel includes a larger number of scanning light images, the second pixel block and the third pixel block may include a smaller number of scanning light images or include no scanning light image. That is, use of the pixel blocks makes it possible to clearly distinguish a region including a scanning light image and a region including no scanning light image. Furthermore, clear changes occur among the first luminance sum of the first pixel block, the second luminance sum of the second pixel block, and the third luminance sum of the third pixel block. It is therefore possible to determine whether or not the determination target pixel in the first pixel block is a pixel showing scanning light based on the relationship among the first luminance sum, the second luminance sum, and the third luminance sum.

In the exemplary embodiment, the first luminance sum is a sum of the luminance values of the pixels included in the first pixel block, the second luminance sum is a sum of the luminance values of the pixels included in the second pixel block, and the third luminance sum is a sum of the luminance values of the pixels included in the third pixel block. Arithmetic processor 7 determines that the determination target pixel is a pixel showing scanning light when an evaluation value obtained by subtracting the second luminance sum and the third luminance sum from a value that is twice the first luminance sum is larger than a first threshold. According to the above configuration, when the evaluation value is larger than the first threshold, the sum of the luminance values of the pixels included in the first pixel block can be larger than the sum of the luminance values of the pixels included in the second pixel block and the third pixel block. It can therefore be regarded that the first pixel block includes a scanning light image and the determination target pixel is a pixel showing scanning light.

In the exemplary embodiment, arithmetic processor 7 determines that the determination target pixel is a pixel showing scanning light when a difference between the second luminance sum and the third luminance sum is smaller than a second threshold in the determination based on the evaluation value. According to the above configuration, a case where one of the second luminance sum and the third luminance sum is markedly larger than the other one of the second luminance sum and the third luminance sum is excluded. For example, when the larger one of the second luminance sum and the third luminance sum is close to the first luminance sum, it is possible that a light image included in the first pixel block is also included in a pixel block having the larger one of the second luminance sum and the third luminance sum. Such a light image can be excluded from scanning light. This improves accuracy of detection of scanning light on a taken image.

In the exemplary embodiment, arithmetic processor 7 changes the first threshold when the second luminance sum and the third luminance sum are less than or equal to a third threshold or when the first luminance sum is larger than or equal to a fourth threshold in the determination based on the evaluation value. According to the above configuration, the first threshold is changed when the second luminance sum and the third luminance sum are small or when the first luminance sum is large. For example, when the second pixel block and the third pixel block each indicate an image of a target object having a dark color on which scanning light is not reflected, the second luminance sum and the third luminance sum become small. Furthermore, the first luminance sum of the first pixel block can also become small. In such a case, the evaluation value tends to become small and is highly likely to be smaller than the first threshold. Meanwhile, for example, when the first pixel block indicates an image of a target object having a bright color on which scanning light is reflected, the first luminance sum becomes large. In such a case, the evaluation value tends to become large and is highly likely to be larger than the first threshold. This may decrease accuracy of determination as to whether or not a determination target pixel is a pixel showing scanning light. In such a case, accuracy of the determination can be improved by changing the first threshold.

In the exemplary embodiment, scanning light is light that is hard to spread in at least two opposite directions. According to the aspect, scanning light forms a dotted or linear image on a taken image. A difference in luminance between scanning light and surroundings thereof on a taken image is more likely to be reflected in a relationship among the first luminance sum, the second luminance sum, and the third luminance sum.

In the exemplary embodiment, widths of the first pixel block, the second pixel block, and the third pixel block in a direction along a scanning line are larger than or equal to a width of scanning light and less than or equal to a width that is twice the width of the scanning light on the taken image. According to the above aspect, scanning light is prevented from being included in all of the first pixel block, the second pixel block, and the third pixel block. Furthermore, scanning light can be included in the first pixel block only. This improves accuracy of the determination concerning the determination target pixel based on the relationship among the first luminance sum, the second luminance sum, and the third luminance sum.

In the exemplary embodiment, the second pixel block and the third pixel block are decided at positions that are spaced apart from the first pixel block by a first interval on the scanning line, and the first interval is larger than or equal to the width of scanning light on the taken image and less than or equal to the width that is twice the width of the scanning light. According to the aspect, scanning light is prevented from being included in two or more of the first pixel block, the second pixel block, and the third pixel block. This improves accuracy of the determination concerning the determination target pixel based on the relationship among the first luminance sum, the second luminance sum, and the third luminance sum.

In the exemplary embodiment, the taken image is an image taken through a bandpass filter that transmits scanning light. According to the aspect, the taken image is an image that shows only scanning light and light having a wavelength close to a wavelength of the scanning light. This simplifies processing for detecting scanning light on the taken image.

According to the exemplary embodiment, distance acquiring unit 8 calculates and outputs a distance to a position at which scanning light was reflected based on a position of a region of the scanning light on the taken image detected by arithmetic processor 7. According to the above configuration, the distance to the position at which the scanning light was reflected calculated based on the position of the scanning light detected with high accuracy can have high accuracy.

### [Modification]

A modification of the processing of arithmetic processor 7 in the image processing device according to the exemplary embodiment is described below. Although arithmetic processor 7 detects whether or not a pixel of a taken image indicates a scanning light image in the exemplary embodiment, arithmetic processor 7 detects whether or not a pixel of a taken image indicates a sunlight image in the present modification. The following mainly describes difference of the modification from the exemplary embodiment.

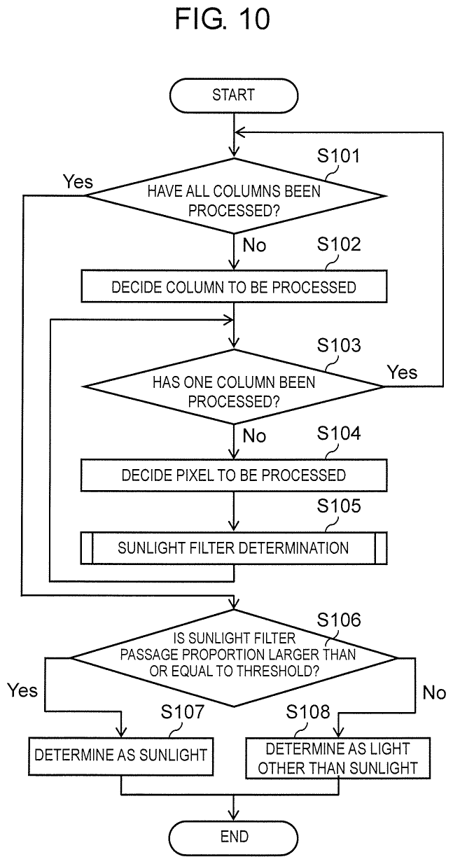

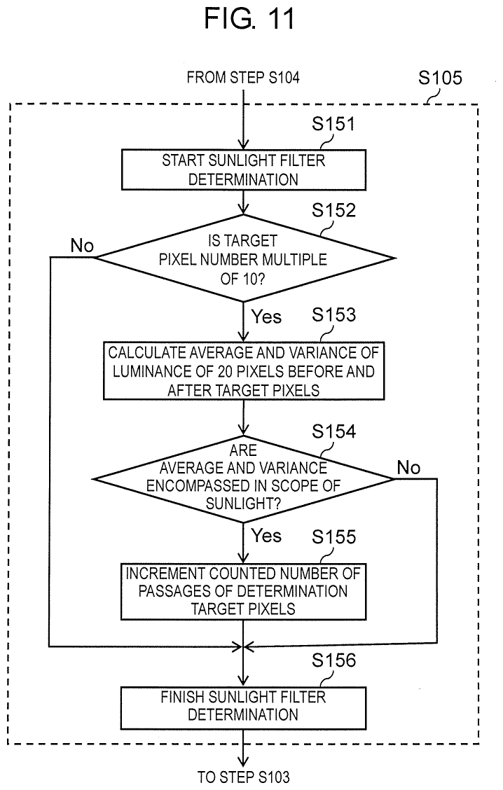

FIG. 10 is a flowchart illustrating an example of an overall flow of processing operation of arithmetic processor 7 according to the modification. FIG. 11 is a flowchart illustrating an example of details of a flow of sunlight filter determination processing in FIG. 10. As illustrated in FIG. 10, in step S101, arithmetic processor 7 determines whether or not image processing of all pixel columns of a taken image has been completed. Arithmetic processor 7 proceeds to step S106 when the image processing has been completed (Yes in step S101), and proceeds to step S102 when the image processing has not been completed (No in step S101). Also in the present modification, the pixel columns to be subjected to the image processing are pixel columns given column numbers 1 to 27 illustrated in FIG. 7. The image processing is processes in steps S102 to S105.

In step S102, arithmetic processor 7 decides, as a pixel column to be subjected to the image processing, a pixel column of a column number that has not been subjected to the processes in steps S103 to S105 that will be described later among the pixel columns given the column numbers 1 to 27.

Next, in step S103, arithmetic processor 7 determines whether or not the processes in S104 and S105 that will be described later have been completed on a plurality of pixels included in the decided pixel column, that is, on all of a plurality of pixels on a scanning line. Arithmetic processor 7 returns to step S101 when the processes have been completed (Yes in step S103), and proceeds to step S104 when the processes have not been completed (No in step S103). Note that not all of the plurality of pixels on the scanning line need be subjected to the processing.

In step S104, arithmetic processor 7 decides, as a pixel to be processed, a pixel that has not been subjected to the process in step S105 that will be described later among the pixels on the scanning line. Furthermore, in step S105, arithmetic processor 7 determines whether or not the pixel decided in step S104 is a pixel that can pass a sunlight filter, that is, performs sunlight filter determination. The sunlight filter is a determination process concerning a pixel in the image processing. Arithmetic processor 7 determines that a luminance value of a pixel that can pass the sunlight filter indicates a sunlight image, and determines that a luminance value of a pixel that cannot pass the sunlight filter does not indicate the sunlight image. Arithmetic processor 7 causes a determination result concerning each pixel to be stored in memory 7c. Alternatively, arithmetic processor 7 may cause the determination result concerning each pixel to be stored in imaging storage 5. Details of the sunlight filter determination processing will be described later. After completion of the process in step S105, arithmetic processor 7 returns to step S103.

In step S106, arithmetic processor 7 determines whether or not a proportion of a number of pixels that passed the sunlight filter to a total number of pixels included in the pixel columns given column numbers 1 to 27 is larger than or equal to a first proportion threshold as a result of the sunlight filter determination performed on all pixels included in the pixel columns given column numbers 1 to 27. Arithmetic processor 7 proceeds to step S107 when the proportion is larger than or equal to the first proportion threshold (Yes in step S106), and proceeds to step S108 when the proportion is less than the first proportion threshold (No in step S106).

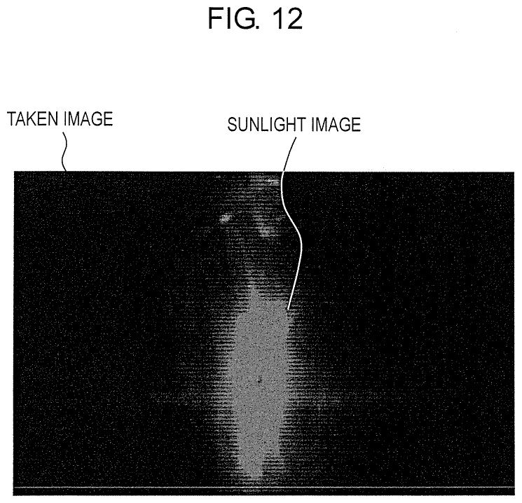

In step S107, arithmetic processor 7 determines that the pixels that passed the sunlight filter indicate a sunlight image. That is, arithmetic processor 7 determines that the taken image includes the sunlight image. For example, as illustrated in FIG. 12, when the taken image includes the sunlight image, the sunlight image is present not in a linear or dotted regular shape but in a shape spreading in a wide range unlike a scanning light image. It is therefore possible to determine whether or not the taken image can include the sunlight image based on a proportion of a number of pixels that indicate sunlight to a total number of pixels of the taken image. When the sunlight filter determination is performed on 27 pixel columns on a taken image made up of horizontal 320 pixels×vertical 180 pixels illustrated in FIG. 7, a number of pixels subjected to the sunlight filter determination is 180/10×27=486. That is, the total number of pixels described above is 486. Note that a reason for the number of pixels described above will be described later. In the present modification, it is assumed that the taken image includes the sunlight image when a number of pixels that passed the sunlight filter among the 486 pixels is larger than or equal to 100. That is, the first proportion threshold is 20%. The first proportion threshold is preferably 15% to 20%.

In step S108, arithmetic processor 7 determines that the pixels that passed the sunlight filter do not indicate the sunlight image.

As described above, arithmetic processor 7 determines whether or not each pixel indicates the sunlight image by performing the sunlight filter determination processing on all pixels included in each scanning line. Furthermore, arithmetic processor 7 determines that the taken image includes the sunlight image when a proportion of a number of pixels that can indicate the sunlight image to a number of pixels subjected to the sunlight filter determination is larger than or equal to the first proportion threshold.

Details of the sunlight filter determination processing in step S105 will be described below. As illustrated in FIG. 11, in step S151, arithmetic processor 7 starts the sunlight filter determination processing on the pixel decided in step S104. In the present modification, the sunlight filter determination processing is performed on some of pixels on each scanning line. This is to increase a processing speed of arithmetic processor 7 and because a region of the sunlight image shown on a taken image is wide. Specifically, the sunlight filter determination processing is performed per 10 pixels. A pixel selected per 10 pixels is a determination target pixel. Note that a number of pixels subjected to the sunlight filter determination processing on a scanning line is not limited to the number described above and may be any number. The determination target pixel selected as a target to be subjected to the sunlight filter determination processing is an example of a sunlight determination target pixel.

Next, in step S152, arithmetic processor 7 determines whether or not a pixel number of the pixel decided in step S104 is a multiple of 10. The pixel number is a number given to a pixel on a scanning line in ascending order in a positive direction on the y-axis. When the pixel number is a multiple of 10, the pixel is a determination target pixel. For example, in the example of FIG. 7, pixels given pixel numbers 1 to 180 are present on a scanning line, and a number of target pixels is 18. Arithmetic processor 7 proceeds to step S153 when the pixel number of the pixel decided in step S104 is a multiple of 10 (Yes in step S152), and proceeds to step S156 when the pixel number of the pixel decided in step S104 is not a multiple of 10 (No in step S152).

In step S153, arithmetic processor 7 sets a determination target region including the determination target pixel on the scanning line. In the present modification, the determination target region is made up of 20 pixels including the determination target pixel. A position of the determination target pixel in the determination target region may be any position. A number of pixels in a determination target region is preferably set such that determination target regions adjacent on the scanning line partially overlap each other. A plurality of determination target regions thus set can cover all pixels on the scanning line. Furthermore, arithmetic processor 7 calculates an average and a variance of luminance values of all pixels (i.e., 20 pixels) in the determination target region. The determination target region that is subjected to the sunlight filter determination processing is an example of a fourth pixel block.

Next, in step S154, arithmetic processor 7 determines whether or not the calculated average and variance are encompassed in a scope of sunlight. Arithmetic processor 7 proceeds to step S155 when the calculated average and variance are encompassed in the scope of sunlight (Yes in step S154), and proceeds to step S156 when the calculated average and variance are not encompassed in the scope of sunlight (No in step S154).

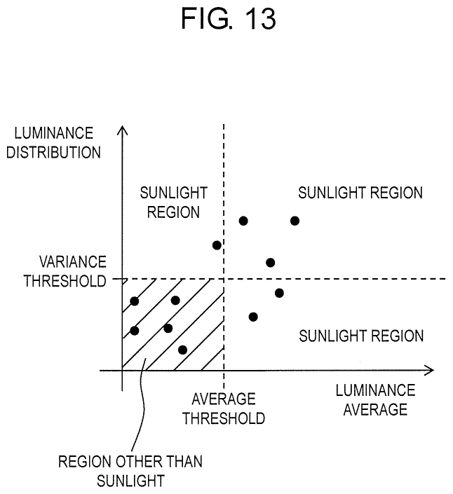

An average and variance of luminance values of sunlight and an average and variance of luminance values of light other than sunlight have a relationship like the one illustrated in FIG. 13. FIG. 13 illustrates an example of a relationship between the average and variance of luminance values of sunlight and the average and variance of luminance values of light other than sunlight. This relationship is obtained because a luminance value of sunlight is relatively large and sunlight is diffusion light. As illustrated in FIG. 13, when an average of luminance values of pixels within a determination target region is larger than an average threshold or when a variance of the luminance values of the pixels within the region is larger than a variance threshold, the region includes sunlight.

Accordingly, when the average calculated in step S153 is larger than the average threshold or when the variance calculated in step S153 is larger than the variance threshold, arithmetic processor 7 determines that the average and the variance are encompassed in the scope of sunlight. That is, arithmetic processor 7 determines that the determination target region includes a sunlight image and that the determination target pixel passes the sunlight filter.

Next, in step S155, arithmetic processor 7 increments a counted number of determination target pixels that pass the sunlight filter on the scanning line and proceeds to step S156. By thus performing the sunlight filter determination processing on all pixels on a single scanning line, a number of determination target pixels that pass the sunlight filter on the scanning line is calculated.

In step S156, arithmetic processor 7 finishes the sunlight filter determination processing on the pixel decided in step S104 and proceeds to step S103. By performing the above processes in steps S151 to S156, arithmetic processor 7 extracts a determination target pixel, determines whether or not the determination target pixel passes the sunlight filter, and when the determination target pixel passes the sunlight filter, increments a counted number of pixels that pass the sunlight filter on a scanning line. Furthermore, arithmetic processor 7 registers processing results obtained in steps S151 to S155 in memory 7c.

As described above, arithmetic processor 7 performs the sunlight filter determination on 27 pixel columns on a taken image made up of horizontal 320 pixels×vertical 180 pixels illustrated in FIG. 7, and further determines whether or not 18 determination target pixels in each of the pixel columns each including 180 pixels pass the sunlight filter. That is, 486 determination target pixels are subjected to the determination as to whether or not a pixel passes the sunlight filter. Arithmetic processor 7 determines that the taken image includes the sunlight image when a proportion of a number of determination target pixels that passed the sunlight filter to the 486 determination target pixels is larger than or equal to the first proportion threshold. For example, in object detection device 1, image processor 6 may exclude such a taken image from a target to be processed by distance acquiring unit 8.

Furthermore, arithmetic processor 7 may determine, for each pixel column, whether or not the pixel column includes the sunlight image. Arithmetic processor 7 counts a number of determination target pixels that passed the sunlight filter on a single pixel column, i.e., on a single scanning line. Arithmetic processor 7 determines that the pixel column on the scanning line includes the sunlight image when a proportion of a number of determination target pixels that passed the sunlight filter to the 18 determination target pixels on the scanning line is larger than a second proportion threshold. In the exemplary embodiment, arithmetic processor 7 may exclude a pixel column including the sunlight image from targets of detection of a scanning light image on a taken image. With this configuration, a taken image including the sunlight image can be used for processing of distance acquiring unit 8. This improves detection accuracy of object detection device 1. Note that the second proportion threshold may be same as the first proportion threshold. Specifically, the second proportion threshold may be 15% to 25%.

Although arithmetic processor 7 extracts a determination target pixel and decides a determination target region based on the determination target pixel on a scanning line, this is not restrictive. Arithmetic processor 7 may decide a determination target region without deciding a determination target pixel on a scanning line. When a number of pixels included in a determination target region and an overlapping length between determination target regions are set in advance, a determination target region can be directly decided.

As described above, according to the present modification, arithmetic processor 7 calculates an average and variance of luminance values of pixels included in a determination target region that is a fourth pixel block including a sunlight determination target pixel, and when the average is larger than an average threshold or the variance is larger than a variance threshold, determines that the sunlight determination target pixel is a pixel showing sunlight. In the above configuration, characteristics of an average and variance of luminance values of a plurality of pixels included in an image of sunlight are different from those of light other than sunlight. The average and variance of sunlight tend to be larger than light other than sunlight. Accordingly, when the average is larger than the average threshold or the variance is larger than the variance threshold, it can be regarded that the determination target region indicates the sunlight image. It can therefore be regarded that the sunlight determination target pixel is a pixel showing sunlight.

In the present modification, arithmetic processor 7 determines that a taken image shows sunlight when a proportion of a number of pixels determined as pixels showing sunlight to a total number of sunlight determination target pixels on the taken image is larger than the first proportion threshold. According to the aspect, it is possible to determine whether or not the sunlight image is present on a whole taken image.

In the present modification, arithmetic processor 7 determines that a taken image on a scanning line shows sunlight when a proportion of a number of pixels determined as pixels showing sunlight to a total number of sunlight determination target pixels on the scanning line is larger than the second proportion threshold. According to the aspect, it is possible to determine, for each scanning line, whether or not the sunlight image is present on a taken image.

### [Other Remarks]

The exemplary embodiment and the modification have been described above as illustrations of the technique disclosed in the present application. However, the technique of the present disclosure is not limited to those exemplary embodiment and modification, and also applicable to modifications of the exemplary embodiment that undergo some changes, replacements, additions, and omissions, for example, as appropriate or to other embodiments. A new exemplary embodiment can also be made by a combination of the components of the exemplary embodiment and the modification.

For example, although the image processing device according to the exemplary embodiment and the modification is provided in an object detection device and is used to detect a position of a target object on which scanning light was reflected based on a position of a scanning light image on a taken image, usage of the image processing devices is not limited to this. The image processing device may be applied to any techniques for detecting an image of specific light having directionality on a taken image.

Note that a general or specific aspect of the present disclosure may be implemented by a system, a device, a method, an integrated circuit, a computer program, or a recording medium such as a computer-readable recording disc or may be implemented by any combination of the system, the device, the method, the integrated circuit, the computer program, and the recording medium. Examples of the computer-readable recording medium include a non-volatile recording medium such as a CD-ROM.

For example, components included in the image processing device and others according to the exemplary embodiment and the modification are typically implemented as a large scale integration (LSI), which is an integrated circuit. The components may be individually implemented as separate chips or some or all of the components may be integrated into one chip. Further, a method for circuit integration is not limited to the LSI, and may be implemented by a dedicated circuit or a general-purpose processor. A field programmable gate array (FPGA) that can be programmed after manufacturing an LSI or a reconfigurable processor that allows reconfiguration of the connection or setup of circuit cells inside the LSI can also be used.

Note that in the exemplary embodiment and the modification, each component may be implemented by dedicated hardware or by executing a software program suitable for each component. Each component may be implemented by causing a program executor such as a processor (e.g., a CPU) to read out and execute a software program recorded on a recording medium such as a hard disk or a semiconductor memory.

Some or all of the components may be an integrated circuit (IC) card that can be detachably attached or a stand-alone module. The IC card or the module is a computer system that includes a microprocessor, a ROM, a RAM, and the like. The IC card or the module may include the LSI or a system LSI. The microprocessor operates in accordance with a computer program, and thus the IC card or the module accomplishes a function thereof. The IC card or the module may have tamper resistance.

Furthermore, the technique of the present disclosure is not limited to an image processing device and may be achieved by an image processing method. The image processing method may be implemented, for example, by an MPU, a CPU, a processor, a circuit such as an LSI, an IC card, or a stand-alone module.

Furthermore, the technique of the present disclosure may be achieved by a software program or a digital signal composed of a software program or may be a non-transitory computer-readable recording medium on which a program is recorded. The program or the digital signal composed of the program may be recorded on a computer-readable recording medium such as a flexible disk, a hard disk, an SSD, a CD-ROM, an MO, a DVD, a DVD-ROM, a DVD-RAM, a Blu-ray (registered trademark) disc (BD), or a semiconductor memory. The program or the digital signal composed of the program may be, for example, transferred over an electric communication line, a wireless or wired communication line, a network represented by the Internet, or data broadcasting. The program or the digital signal composed of the program may be implemented by another independent computer system by being transferred on a recording medium or over a network.

All of the numerals such as ordinal numbers and numbers are illustrative examples for specific description of the technique of the present disclosure, and the present disclosure is not limited by the numerals illustrated above. Furthermore, connection relationships between components are illustrative examples for specific description of the technique of the present disclosure, and connection relationships that implement the functions of the present disclosure are not limited to these. A way in which functional blocks are divided in the block diagrams is an example, and a plurality of functional blocks may be implemented as a single functional block, a single functional block may be divided into a plurality of functional blocks, and a certain function may be transferred to another functional block. Furthermore, functions of a plurality of functional blocks that have similar functions may be processed in parallel or in a time-sharing manner by a single piece of hardware or software.

### INDUSTRIAL APPLICABILITY

The present disclosure is applicable to a technique for detecting light on an image of a target object irradiated with the light.

What is claimed is:

1. An image processing device comprising:
an irradiator that irradiates a space with irradiating light having directionality;
an imaging unit that takes an image of the space; and
a processor that detects a region irradiated with the irradiating light on the taken image,
wherein the processor
scans the taken image along a scanning line,
decides, on the scanning line, a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block,
calculates a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block, and
determines whether or not the determination target pixel is a pixel showing the irradiating light based on a relationship among the first luminance sum, the second luminance sum, and the third luminance sum.

2. An image processing device comprising:
a storage in which a taken image of a space irradiated with irradiating light having directionality is stored; and
a processor that detects a region irradiated with the irradiating light on the taken image,
wherein the processor
scans the taken image along a scanning line,
decides, on the scanning line, a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block,
calculates a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block, and
determines whether or not the determination target pixel is a pixel showing the irradiating light based on a relationship among the first luminance sum, the second luminance sum, and the third luminance sum.

3. The image processing device according to claim 1, wherein
the first luminance sum is the sum of the luminance values of the at least one pixel included in the first pixel block;
the second luminance sum is the sum of the luminance values of the at least one pixel included in the second pixel block;
the third luminance sum is the sum of the luminance values of the at least one pixel included in the third pixel block; and
the processor calculates an evaluation value by subtracting the second luminance sum and the third luminance sum from a value that is twice the first luminance sum and determines that the determination target pixel is a pixel showing the irradiating light when the evaluation value is larger than a first threshold.

4. The image processing device according to claim 3, wherein the processor further determines that the determination target pixel is the pixel showing the irradiating light when a difference between the second luminance sum and the third luminance sum is less than a second threshold.

5. The image processing device according to claim 3, wherein the processor changes the first threshold when each of the second luminance sum and the third luminance sum is less than or equal to a third threshold or when the first luminance sum is larger than or equal to a fourth threshold.

6. The image processing device according to claim 1, wherein the processor
decides a fourth pixel block including a plurality of pixels including a sunlight determination target pixel on the scanning line,
calculates an average and a variance of luminance values of the pixels included in the fourth pixel block, and
determines that the sunlight determination target pixel is a pixel showing sunlight when the average is larger than an average threshold or when the variance is larger than a variance threshold.

7. The image processing device according to claim 6, wherein
the processor determines that the taken image is an image showing sunlight when a proportion of the pixel showing sunlight determined to all of the sunlight determination target pixel on the taken image is larger than a first proportion threshold.

8. The image processing device according to claim 6, wherein
the processor determines that the taken image on the scanning line shows sunlight when a proportion of the pixel showing sunlight determined to all of the sunlight determination target pixel on the scanning line is larger than a second proportion threshold.

9. The image processing device according to claim 1, wherein the irradiating light is light that is hard to spread in at least two opposite directions.

10. The image processing device according to claim 1, wherein each of widths of the first pixel block, the second pixel block, and the third pixel block in a direction along the scanning line is larger than or equal to a width of the irradiating light on the taken image and less than or equal to a width that is twice the width of the irradiating light.

11. The image processing device according to claim 1, wherein
the second pixel block and the third pixel block are decided at positions that are spaced apart from the first pixel block by a first interval on the scanning line; and
the first interval is larger than or equal to a width of the irradiating light on the taken image and less than or equal to a width that is twice the width of the irradiating light.

12. The image processing device according to claim 1, wherein the taken image is an image taken through a bandpass filter that transmits the irradiating light.

13. A distance detection device comprising:
the image processing device according to claim 1; and
a distance acquiring unit that calculates and outputs a distance to a position of reflection of the irradiating light based on a position, on the taken image, of the region irradiated with the irradiating light detected by the processor.

14. The image processing device according to claim 2, wherein
the first luminance sum is the sum of the luminance values of the at least one pixel included in the first pixel block;
the second luminance sum is the sum of the luminance values of the at least one pixel included in the second pixel block;
the third luminance sum is the sum of the luminance values of the at least one pixel included in the third pixel block; and
the processor calculates an evaluation value by subtracting the second luminance sum and the third luminance sum from a value that is twice the first luminance sum and determines that the determination target pixel is a pixel showing the irradiating light when the evaluation value is larger than a first threshold.

15. The image processing device according to claim 2, wherein the processor
decides a fourth pixel block including a plurality of pixels including a sunlight determination target pixel on the scanning line,
calculates an average and a variance of luminance values of the pixels included in the fourth pixel block, and
determines that the sunlight determination target pixel is a pixel showing sunlight when the average is larger than an average threshold or when the variance is larger than a variance threshold.

16. The image processing device according to claim 2, wherein each of widths of the first pixel block, the second pixel block, and the third pixel block in a direction along the scanning line is larger than or equal to a width of the irradiating light on the taken image and less than or equal to a width that is twice the width of the irradiating light.

17. The image processing device according to claim 2, wherein
the second pixel block and the third pixel block are decided at positions that are spaced apart from the first pixel block by a first interval on the scanning line; and
the first interval is larger than or equal to a width of the irradiating light on the taken image and less than or equal to a width that is twice the width of the irradiating light.

18. An image processing method comprising:
acquiring a taken image of a space irradiated with irradiating light having directionality; and
detecting a region irradiated with the irradiating light on the taken image, wherein
in the detecting the region irradiated with the irradiating light,
the taken image is scanned along a scanning line,
a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block are decided on the scanning line,
a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block are calculated, and
whether or not the determination target pixel is a pixel showing the irradiating light is determined based on a relationship among the first luminance sum, the second luminance sum, and the third luminance sum.

19. The image processing method according to claim 18, wherein
the first luminance sum is the sum of the luminance values of the at least one pixel included in the first pixel block;
the second luminance sum is the sum of the luminance values of the at least one pixel included in the second pixel block;
the third luminance sum is the sum of the luminance values of the at least one pixel included in the third pixel block; and
in determining whether or not the determination target pixel is a pixel showing the irradiating light,
an evaluation value is calculated by subtracting the second luminance sum and the third luminance sum from a value that is twice the first luminance sum, and it is determined that the determination target pixel is a pixel showing the irradiating light when the evaluation value is larger than a first threshold.

20. A non-transitory storage medium storing a program causing a computer to execute a process comprising:
acquiring a taken image of a space irradiated with irradiating light having directionality; and
detecting a region irradiated with the irradiating light on the taken image, wherein
in the detecting the region irradiated with the irradiating light,
the taken image is scanned along a scanning line,
a first pixel block that includes at least one pixel including a determination target pixel, a second pixel block that includes at least one pixel and is adjacent to the first pixel block, and a third pixel block that includes at least one pixel and is adjacent to the first pixel block on a side opposite to the second pixel block are decided on the scanning line,
a first luminance sum based on a sum of luminance values of the at least one pixel included in the first pixel block, a second luminance sum based on a sum of luminance values of the at least one pixel included in the second pixel block, and a third luminance sum based on a sum of luminance values of the at least one pixel included in the third pixel block are calculated, and
whether or not the determination target pixel is a pixel showing the irradiating light is determined based on a relationship among the first luminance sum, the second luminance sum, and the third luminance sum.
